(19) United States
(12) Patent Application Publication
(10) Pub. No.: US 2003/0104715 A1
(43) Pub. Date: Jun. 5, 2003

(54) Signal-transmitting device

(75) Inventors: Sheng-Nan Tsai, Taoyuan Hsien (TW); Chin-Lung Kuo, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyua Hsien (TW)

(21) Appl. No.: 10/307,621

(22) Filed: Dec. 2, 2002

(30) Foreign Application Priority Data
Dec. 3, 2001 (TW) 90221007

(51) Int. Cl. H01R 4/66; H01R 31/08

(52) U.S. Cl. 439/95

(57) ABSTRACT

A signal-transmitting device for a printed circuit board having plural through holes and an electronic circuit is provided. The signal-transmitting device includes a connector having plural equipotential pins for being mounted in the plural through holes of the printed circuit board, and a conductive frame having plural conducting terminals respectively corresponding to the plural equipotential pins of the connector, wherein each the equipotential pin is mounted in the respective through hole of the printed circuit board via the respective conducting terminal of the conductive frame and at least one of the conducting terminals provides an equipotential signal for the electronic circuit of the printed circuit board.

### FIELD OF THE INVENTION

The present invention is related to a signal-transmitting device and more particularly, to a signal-transmitting device for a printed circuit board.

### BACKGROUND OF THE INVENTION

As electronic technology evolves, new types of electrical devices with advanced functions are developed which has a small volume and is easy to be carried. Meanwhile the core of an electronic product is the printed circuit board (PCB). Naturally, the occupied volume of a PCB is the most important key point that deeply influences the design of the electronic product.

A PCB is used for carrying electrical devices, conducting electronic circuits, and transmitting electronic signals, so as to provide a stable operating condition. Please refer to FIG. 1. It illustrates a vertical view of a PCB according to the prior art. The PCB 1 has plural connecting blocks 11 to be disposed for respective connectors. Each connecting block 11 further includes plural pin-through holes for passing respective pins of a connector therethrough. Meanwhile each pin-through hole is connected to an electronic circuit 12 via a trace disposed on the PCB 1. For example, a connecting block 111 desires to be connected with the electronic circuit 12. Because there are other connecting blocks disposed around the connecting block 111, the PCB 1 can't provide enough space for pin-through holes of the connecting block 111 to be connected to the electronic circuit 12 via an extra trace. In another word, there is no enough space for a trace to be disposed on the surface of the PCB 1.

For a layout technique of the prior art, there have been several methods introduced to solve the problem of lack of space for being distributed to signal-transmitting wires and metal traces. Please refer to FIG. 2. It illustrates a prior method of connecting several pin-through holes in response to equipotential pins of a connector by means of soldering. In FIG. 2, a connecting block 21 of a PCB 2 has pin-through holes 211 in response to equipotential pins of a connector to be connected together by means of soldering, and then the equipotential pin-through holes 211 of the connecting block 21 is connected to an electronic circuit 22 via a metal trace. However, it is hard to control the occupied surface of a soldering wire 212 during the period of soldering. Furthermore, there should be a lot of signal noise produced by other electronic signals and the signal noise will influence other circuits and always introduce the instability of the system.

Please refer to FIG. 3. It illustrates a prior method of connecting several equipotential pin-through holes of a connecting block to an electronic circuit by means of wiring. In FIG. 3, a connecting block 31 of a PCB 3 has pin-through holes 311 in response to equipotential pins of a connector to be connected to the electronic circuit 32 by means of wiring of plural wire 33, so as to improve the drawback of lack of surface space on PCB 3 for being distributed to metal traces. However the additional plural wires 33 also occupy a lot of space and have to be connected with PCB 3 by means of soldering. Hence, the above method will introduce a lot of extra processes and cost a lot. Furthermore, the appearance of the PCB 3 must be in disorder because of the extra plural wires 33 and the assembly would be inconvenient to be used.

Therefore, it is tried to rectify those drawbacks and provide a signal-transmitting device for a printed circuit board by the present applicant.

### SUMMARY OF THE INVENTION

It is therefore a primary objective of the present invention to provide a signal-transmitting device of a printed circuit board for solving the problem of lack of surface space to be distributed to signal-transmitting wires and metal traces.

According to the present invention, the signal-transmitting device for a printed circuit board having plural through holes and an electronic circuit, includes a connector having plural equipotential pins for being mounted in the plural through holes of the printed circuit board; and a conductive frame having plural conducting terminals respectively corresponding to the plural equipotential pins of the connector, wherein each the equipotential pin is mounted in the respective through hole of the printed circuit board via the respective conducting terminal of the conductive frame and at least one of the conducting terminals provides an equipotential signal for the electronic circuit of the printed circuit board.

Certainly, the printed circuit board can be a signal-layer printed circuit board.

Preferably, the printed circuit board is a multiple-layer printed circuit board.

Preferably, the plural conducting terminal is a medium of signal-transmitting.

Preferably, the connector further connects thereto an external interface for transmitting an electronic signal between the external interface and the electronic circuit of the printed circuit board.

Certainly, the equipotential can be a grounding potential.

It is therefore a secondary objective of the present invention to provide a conductive frame for connecting a connector having plural equipotential pins with a printed circuit board having plural through holes, so as to solve the problem of lack of surface space to be distributed to signal-transmitting wires and the metal trace.

According to the present invention, the conductive frame includes plural conducting terminals corresponding to the plural equipotential pins of the connector, wherein each the equipotential pin is allocated in the respective through hole of the printed circuit board via the respective conducting terminal of the conductive frame and at least one of the conducting terminals provides an equipotential signal for the electronic circuit of the printed circuit board.

Preferably, the printed circuit board is a signal-layer printed circuit board.

Certainly, the printed circuit board can be a multiple-layer printed circuit board.

Preferably, the plural conducting terminals connect the plural equipotential pins of the connector.

Certainly, the equipotential can be a grounding potential.

The foregoing and other features and advantages of the present invention will be more clearly understood through the following descriptions with reference to the drawings, wherein:

### BRIEF DESCRIPTION OF THE DRAWING

FIG. 1 illustrates a PCB according to the prior art;

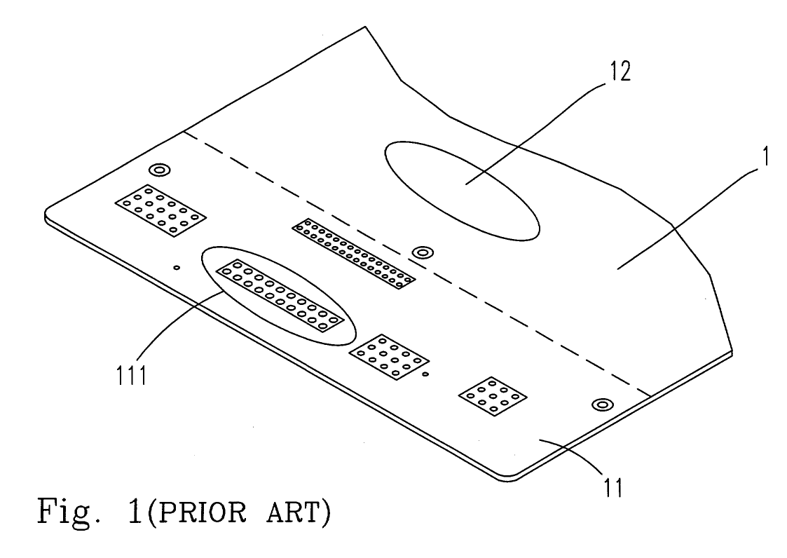

FIG. 2 illustrates a prior PCB having several pin-through holes in response to equipotential pins of a connector to be connected together by means of soldering;

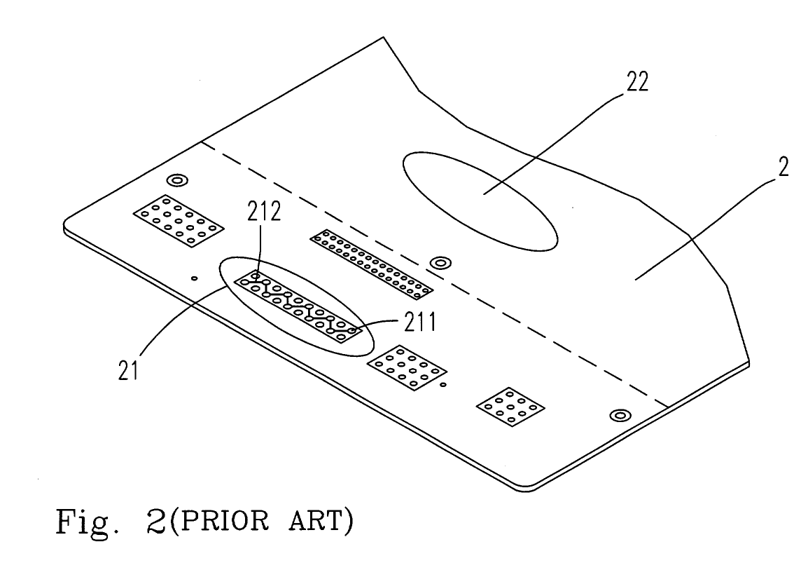

FIG. 3 illustrates a prior PCB having several equipotential pin-through holes of a connecting block connected to an electronic circuit by means of wiring;

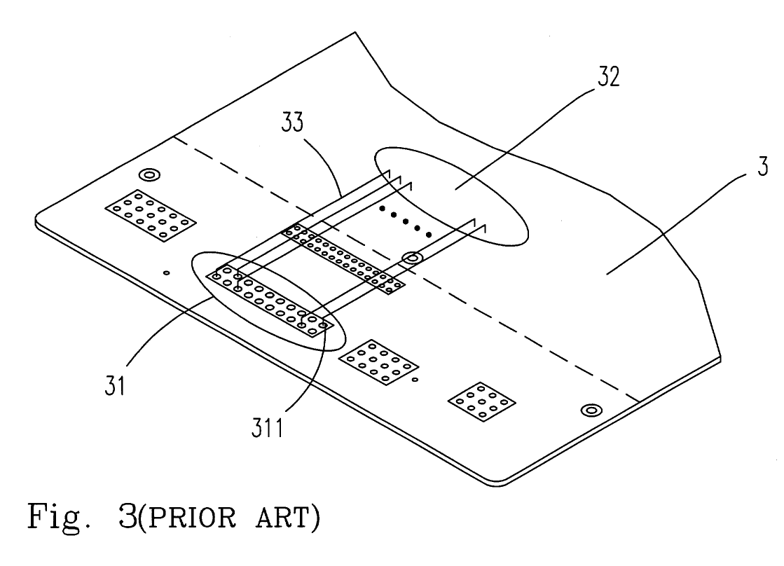

FIG. 4 illustrates a signal-transmitting device for a printed circuit board according to the present invention; and

FIG. 5 illustrates pin-through holes of a single-layer PCB according to the present invention.

### DETAILED DESCRIPTION OF THE PREFERRED EMBODIMENTS

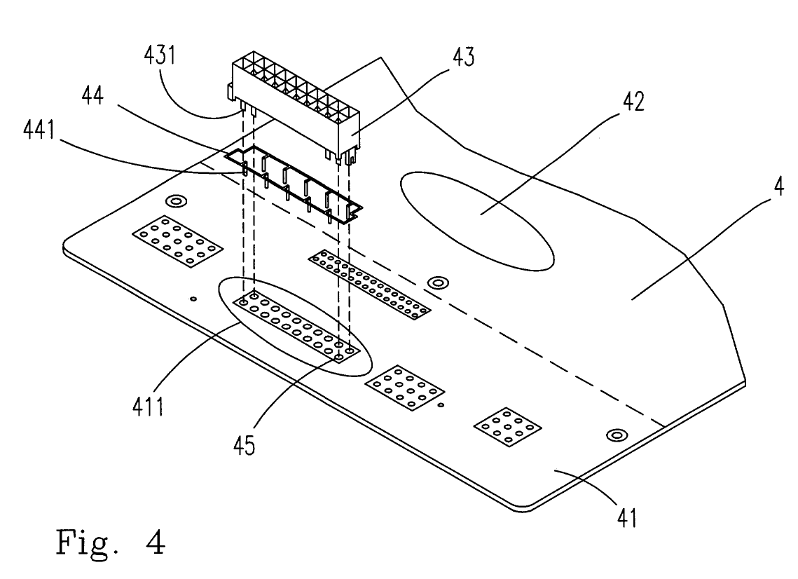

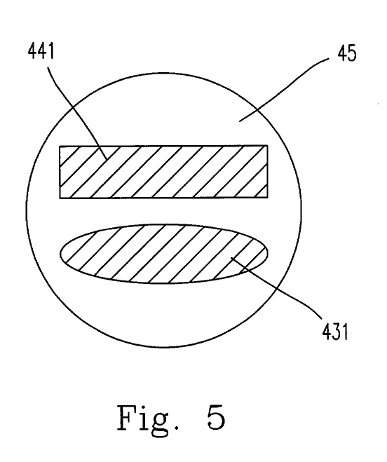

Please refer to FIG. 4. It illustrates a signal-transmitting device for a PCB of the first embodiment of the present invention. The signal-transmitting device of a single-layer PCB 4 has plural through holes respectively disposed in plural connecting region 41 and an electronic circuit 42. Because a connecting block 411 of the connecting region 41 is disposed around other connecting blocks, the single-layer PCB 4 can't provide enough surface space for disposing an extra metal trace. For solving the above problem, the present invention provides the signal-transmitting device. In FIG. 4, the signal-transmitting device includes a connector 43 and a conductive frame 43, wherein the connector 43 has plural equipotential pins 431 for being mounted in the plural through holes of the PCB 4, and the conductive frame 44 has plural conducting terminals 441 respectively corresponding to the plural equipotential pins 431 of the connector 43. Meanwhile the equipotential pin 43 is mounted in the respective through hole of the PCB 4 via the respective conducting terminal 441 of the conductive frame 44 and at least one of the conducting terminals 441 provides an equipotential signal for the electronic circuit 42 of the printed circuit board 4. The connector 43 further connects thereto an external interface for transmitting an electronic signal between the external interface and the electronic circuit 42 of the PCB, wherein the external interface can be an electronic element, plural electronic elements or a conducting wire connected to another element, and the external interface also can be integrated with the connector 43 for saving the space. In the present invention, each conductive terminal 441 is mounted in the respective through hole 45 of the PCB 4 for allocating the conductive frame 44 on the PCB 4. Then the connector 43 is allocated on PCB 4 via the conductive frame 44, wherein the plural equipotential pins 431 are respectively corresponding to the plural conductive terminal 441 and connected the plural conductive terminal 441 thereto while the connector 43 is allocated on the PCB 4. The conductive frame 44 provides the connector 43 with plural conductive terminals 441 and thereby an equipotential signal of the connecter 43 can be transmitted to the electronic circuit 42 via a metal trace connected with at least one of the conducting terminals 441. Therefore, the number of the metal traces will be decreased; the wires and extra pin-through holes won't be introduced, and the problem of lack of surface space in a single-layer PCB will be solved. FIG. 5 illustrates pin-through holes of a single-layer PCB according to the present invention. In FIG. 5, the conductive terminal 441 of the conductive frame 44 and the equipotential pin 431 of the connector 43 are allocated into the same pin-through hole simultaneously and no extra pin-through hole should be introduced, so as to solve the problem of lack of surface space to be distributed to signal-transmitting wires and the metal trace. Certainly, the present invention can be applied for a double-layer PCB or multi-layer PCB. The equipotential can be a grounding potential and other electrical signals can be introduced in the present invention, too.

Accordingly, the conductive frame 44 of the present invention is disposed between the connector 43 and the PCB 4, so as to connect the equipotential pins 431 of the connector 43. Meanwhile the number of the metal traces disposed on the surface of the PCB is decreased for omitting a lot of occupied space. Extra manufacturing processes shouldn't be introduced for connecting a connector and an electronic circuit. Obviously, the present invention provides a convenient signal-transmitting device easy to be manufactured and doesn't cost a lot. It is practicability in the industry.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A signal-transmitting device for a printed circuit board having plural through holes and an electronic circuit, comprising:
a connector having plural equipotential pins for being mounted in said plural through holes of said printed circuit board; and
a conductive frame having plural conducting terminals respectively corresponding to said plural equipotential pins of said connector, wherein each said equipotential pin is mounted in said respective through hole of said printed circuit board via said respective conducting terminal of said conductive frame and at least one of said conducting terminals provides an equipotential signal for said electronic circuit of said printed circuit board.

2. The signal-transmitting device according to claim 1, wherein said printed circuit board is a signal-layer printed circuit board.

3. The signal-transmitting device according to claim 1, wherein said printed circuit board is a multiple-layer printed circuit board.

4. The signal-transmitting device according to claim 1, wherein said plural conducting terminal is a medium of signal-transmitting.

5. The signal-transmitting device according to claim 1, wherein said connector further connects thereto an external interface for transmitting an electronic signal between said external interface and said electronic circuit of said printed circuit board.

6. The signal-transmitting device according to claim 1, wherein said equipotential is a grounding potential.

7. A conductive frame for connecting a connector having plural equipotential pins with a printed circuit board having plural through holes, comprising:
plural conducting terminals corresponding to said plural equipotential pins of said connector, wherein each said equipotential pin is allocated in said respective through hole of said printed circuit board via said respective conducting terminal of said conductive frame and at least one of said conducting terminals provides an equipotential signal for said electronic circuit of said printed circuit board.

8. The conductive frame according to claim 7, wherein said printed circuit board is a signal-layer printed circuit board.

9. The conductive frame according to claim 7, wherein said printed circuit board is a multiple-layer printed circuit board.

10. The conductive frame according to claim 1, wherein said plural conducting terminals connect said plural equipotential pins of said connector.

11. The conductive frame according to claim 7, wherein said equipotential is a grounding potential.
